(19) United States
(12) Patent Application Publication
(10) Pub. No.: US 2023/0385564 A1
(43) Pub. Date: Nov. 30, 2023

(54) INFORMATION PROCESSING SYSTEM AND METHOD THEREOF

(71) Applicant: CELL DSGN PRIVATE LIMITED, Ahmedabad (IN)

(72) Inventor: HIMANSHU SHANI, Ahmedabad (IN)

(73) Assignee: CELL DSGN PRIVATE LIMITED, Ahmedabad, GJ (IN)

(21) Appl. No.: 18/248,608

(22) PCT Filed: Oct. 19, 2021
(86) PCT No.: PCT/IN2021/050992

§ 371 Date: Apr. 11, 2023

(30) Foreign Application Priority Data
Oct. 22, 2020 (IN) 202021046188

(51) Int. Cl. G06K 7/10; G06K 19/02

(52) U.S. Cl. CPC G06K 7/10128; G06K 19/027

(57) ABSTRACT

An information processing system (100) includes at least one device ‘B’ for providing article related information relating to a corresponding article in real-time. Each article is associated with at least one identifier. A server (30) is configured to store the article related information provided by the device(s) ‘B’ in real-time. At least one chip tag (20) is in communication with the at least one electronic device ‘B’ and the server (30). The server (30) and the device ‘A’ and ‘B’ having a communication channel (40). Each of the devices ‘B’ is configured to upload the article related information in real-time at each manufacturing step during manufacturing of the article. The reader of the device ‘A’ is configured to scan the chip tag (20) and access the article related information at any given time during the manufacturing of the article and/or after the article has been manufactured.

### FIELD OF INVENTION

The present invention relates to a processing system. More specifically, the invention includes a processing system involving a chip tag.

### BACKGROUND

Tailoring and manufacturing of fabrics and associated products has always been a sophisticated and sensitive field. The main focus of the industry is avoidance of defects in the finished products and to ensure the quality of the same. Defects in the finished products may be caused due to error on the part of a worker and/or a machine. In case of machine errors, the improper working of the machine can cause imperfections in the design and stiches of an article. Human errors may be result of by lack of focus or irresponsibility which ultimately affects the quality of the products and hence, the goodwill of the manufacturer. Hence, evaluation of performance of the workers plays a critical role.

Evaluation of performance is a complicated task and in case of textile industry, it becomes even more complicated due to large number of workers involved at various stages of manufacturing the product. Other than evaluation of performance, the other limitation of this industry is the fact that there is no way available with the help of which the manufacturer can procure updates on the progress of manufacturing of the product in real-time.

In order to evaluate performance and receive updates, various methods have been adopted to procure article related information at each of the stages of manufacturing and thereafter examining the quality of workers based upon the same. For example, the weekly reports of the tailors are collected from the supervisors which can further make the process non reliable and complicated. Moreover, human involvement in evaluation can leads more chances of error. However, all of these methods are very time consuming and inaccurate.

One of the other solutions of this problem is proposed by N. G. et. al titled article ‘Simple instruments for quality control by finishers and tailors.’ The quality mechanism includes cascaded machines which are inexpensive, robust and easy to use. After manufacturing, the stitched clothes are passed through the machines and evaluated. However, this mechanism does not yield any information related to the worker in case of any defect and hence, tracing the worker responsible for the defect(s) cannot be possible.

Therefore, it is necessary to propose solution so that quality check on each and every process of manufacturing can be made possible and also quality of workers can be improved.

### SUMMARY OF INVENTION

The present invention relates to an information processing system (or system). The system allows uploading, storing and accessing predefined data in real-time/off-line using a chip tag. The system of the present invention may be employed for any given application involving data transmission in real-time.

The foregoing features and other features as well as the advantages of the invention will become more apparent from the following detailed description, which proceeds with reference to the accompanying figures.

### BRIEF DESCRIPTION OF DRAWINGS

The summary above, as well as the following detailed description of illustrative embodiments, is better understood when read in conjunction with the apportioned drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1 discloses an exemplary architecture of a system 100 in accordance with an embodiment of the present invention.

FIG. 1a discloses an alternate architecture of the system 100 in accordance with an embodiment of the present invention.

FIG. 2 discloses data access by device ‘A’ in accordance with an embodiment of the present invention.

FIG. 3 discloses an article 10 in accordance with an embodiment of the present invention.

### DETAILED DESCRIPTION OF FIGURES

Prior to describing the invention in detail, definitions of certain words or phrases used throughout this patent document will be defined: the terms “include” and “comprise”, as well as derivatives thereof, mean inclusion without limitation; the term “or” is inclusive, meaning and/or; the phrases “coupled with” and “associated therewith”, as well as derivatives thereof, may mean to include, be included within, interconnect with, contain, be contained within, connect to or with, couple to or with, be communicable with, cooperate with, interleave, juxtapose, be proximate to, be bound to or with, have a property of, or the like; Definitions of certain words and phrases are provided throughout this patent document, and those of ordinary skill in the art will understand that such definitions apply in many, if not most, instances to prior as well as future uses of such defined words and phrases.

Wherever possible, same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Particular embodiments of the present disclosure are described herein below with reference to the accompanying drawings, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The present invention relates to an information processing system (or system). The system allows uploading, storing and accessing predefined data in real-time/off-line using a chip tag. The system of the present invention may be employed for any given application involving data transmission in real-time. As an exemplary application, the description discloses the use of the system in a manufacturing set-up to procure and transmit one or more article related information to an end user. The end user may be at least one of a manufacturer or a consumer.

The article related information may be any information relating to the product details of the article, the details of the workers involved in manufacturing the article at different stages, the progress of manufacturing at one or more stages of manufacturing, manufacturer of the article, washing and handling instructions of the article, unit article code/number etc.

The transmission of the article related information using the system of the present invention may be useful for the manufacturer for evaluation of the quality of the article. Further, the system allows the manufacturer to receive live updates of the article as it passes through several stages of manufacturing and processing. Alternately/additionally, the system allows the consumer to gather article related information related to the article such as instructions relating to the article, make of the article, details of the workers and company associated with the article, etc.

Further, in few cases where the article includes defects, the system of the present invention helps to identify one or more workers associated with the defected article. In such a scenario, the present invention may help a manufacturing setup to evaluate the performance of the workers thereby enhancing the efficiency of the workers and also the quality of the articles.

Therefore, the present system may be used to monitor the inventory storage, production control, retail management, brand segregation, cloth care labeling and customer relationship management.

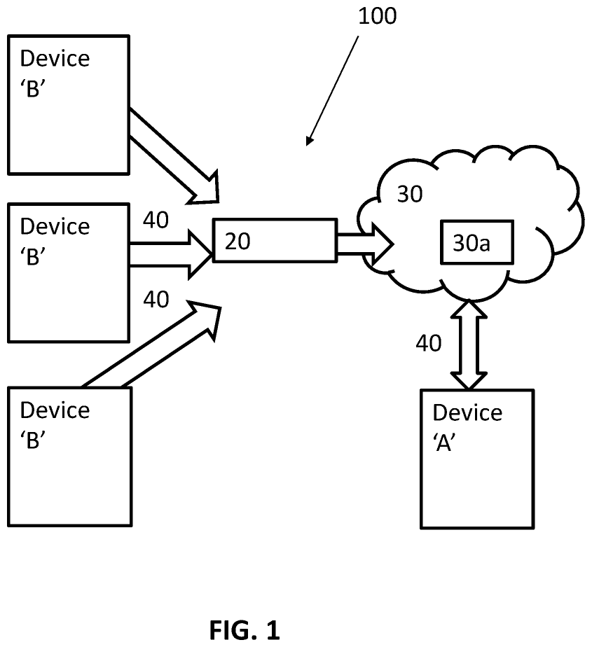

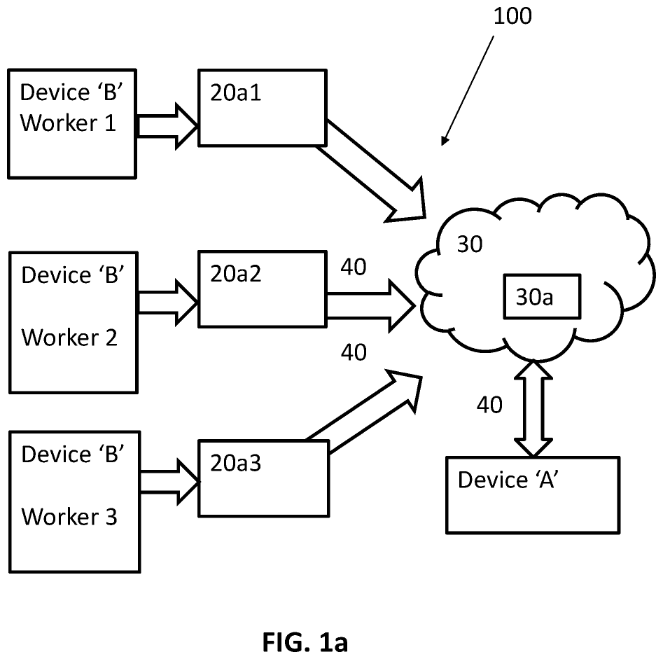

FIG. 1 depicts a system 100 for uploading, storing and accessing data through at least one chip tag 20 as a client/server architecture used in an embodiment of the present invention. A “client device” is a member of a class or group that uses the services of another class or group to which it is not related. In the context of a computer network, such as the Internet, a client device is a process (i.e. roughly a program or task) that requests a service which is provided by another process, known as a server program. The client device process uses the requested service without having to know any working details about the server program or the server itself. In networked systems, a client device process usually runs on a computer that accesses shared network resources provided by another computer running a corresponding server process.

A “server” is typically a remote computer system or a processor with high end storage and processing speed that is accessible over a communications medium such as the Internet. The client device process may be active on a portable device, and communicate with the server process over a communications medium that allows multiple client devices to take advantage of the article related information gathering capabilities of the server. The communication medium may be wired or wireless which may follow XMLHttpRequest, Server-Sent Events, WebSocket, HTTP, or Server to server communication.

Thus, the server essentially acts as an article related information provider for a computer network.

The system 100 includes at least one electronic device ‘A’ (or device ‘A’), at least one electronic device ‘B’ (or device ‘B’), at least one chip tag 20, a server 30 and a communication channel or a network 40 which is used for establishing communication between them.

The one or more device ‘B’ may be held by corresponding workers that are associated with the article at various stages of manufacturing of the article. The device ‘B’ may include, without limitation, a personal computer, a laptop, a notebook, a handheld computer, a set-top box, a PDA, a mobile phone and the like. Therefore, the device ‘B’ may be an electronic device having input capabilities.

In an embodiment, the device ‘B’ may include software resident on the device ‘B’ such as a web application, a mobile application, a software application and the like. Alternately, if the software is resident on cloud, the device ‘B’ may access the software via network. The software application pertaining to the device ‘B’ may be called worker device software (WDS). The computer program pertaining to the device ‘A’ may be called access device software (ADS). In an embodiment, ADS and WDS may be owned by a third-party, say, and manufacturer.

The one or more devices ‘B’ of the present invention are used for uploading article related information in real-time. The devices ‘B’ are hence responsible for providing article related information relating to a corresponding article in real-time. As shown in FIG. 1, each of the devices ‘B’ may be operatively coupled to a common chip tag 20. Alternately, each of the devices ‘B’ may be operatively coupled to respective chip tags 20a1, 20a2, 20a3 as shown in FIG. 1a. The data uploaded by each of the workers at each and every stage of the manufacturing of the article is saved in the chip tag 20. Each of the electronic devices ‘B’ is configured to upload the article related information in real-time at each manufacturing step during manufacturing of the article.

Each article may be associated with an identifier for example, a product identification reference (PIR). Hence, the data relating to a particular article is uploaded and saved with respective PIR. Additionally and optionally, a unique code may be assigned to each worker/stage.

For data storage, each of the workers via device ‘B’ may upload the relevant details such as the name and contact details via the said electronic devices ‘B’. Alternately, the workers may facilitate access to a live stream of the process details like dying of yarns/fabrics, spinning of yarn, etc. In case, the chip tag 20 is provided with a memory, the said details may be saved in the chip tag 20 directly. Alternately, the said details may be saved on a server 30 as shown in FIG. 1.

The chip tag 20 may be a smart chip device encoded with the article related information (or data). The chip tag 20 may be in communication with the at least one electronic device ‘B’ and the server 30. The chip tag 20 being encoded with the article related information received from the at least one electronic device ‘B’ in real-time.

The chip tag 20 include an antenna and semiconductor components which are embedded onto a thin plastic substrate of 100 to 200 nm, for example polymer, polyvinyl chloride (PVC), polyethylene terephthalate (PET), phenolics, polyesters, styrene, or paper via copper etching or hot stamping. The fastest and cheapest process is via screen printing using conductive ink containing copper, nickel, or carbon. The chip tag 20 may be a semiconductor or silicon chip employing a technology like RFID (Radio frequency Identification), NFC (Near field communication), etc. In an embodiment, the chip tag 20 uses NFC technology.

The data stored in the chip tag 20 may be alphanumeric, numeric, binary, etc. As mentioned above, the data in the chip tag 20 may be stored by the workers associated with the manufacturing of the article at different stages through the one or more device ‘B’ in real-time. Alternately, in few instances, the data may be pre-programmed or assigned by the manufacturer. The size of the data may be without limitation 16-bits, 32-bits, 64-bits and 128-bits, etc.

For example, in case, the article is a fabric, the hand spinners involved at yarn stage may upload their name, batch number and contact details. Likewise, other workers such as dyers, hand painters, weavers, tailors and hand embroiders may upload their respective details.

The said data encoded in the chip tag 20 in relation to a particular article may be easily accessed and may perform interrogator functions by the end user for a pre-defined purpose using the device ‘A’.

The above data may be useful for the manufacturer to procure live updates of the article as it passes through several stages of manufacturing and processing. In an embodiment, the system 100 is used for quality check of manufactured articles and performance evaluation of workers. In such a case, the system 100 may help a manufacturer to identify the one or more workers responsible for making/processing/manufacturing the defected article through the data stored in the chip tag 20. In case of a defected article, the manufacturer may directly contact the worker responsible for a given defect in the article. Therefore, the present invention helps a manufacturer to evaluate the performance of the workers thereby enhancing the efficiency of the workers as well as the quality of the articles.

Alternately/additionally, the data may correspond to article related information and is targeted for the consumer of the article. For example, the data may relate to the materials used for making the article, mode of washing in case the article is a fabric, any precautions related to the article, date and place of manufacturing, etc.

The one or more device ‘A’ may be held by at least one end user i.e. at least one manufacturer and/or at least one consumer. In an embodiment, the device ‘A’ includes a basic user interface with user application for reader configuration and supports multiple protocols like EPC and ISO. The device ‘A’ may be connected with the other devices of the system through serial or Ethernet (wired, wireless) connection, or Bluetooth (handheld), etc. The device ‘A’ may include without limitation, a personal computer, a laptop, a notebook, a handheld computer, a set-top box, a personal digital assistant (PDA), a mobile phone and the like. Therefore, the device ‘A’ may be any electronic device having capturing, scanning and/or processing capabilities such as a specialized reader, mobile phone (installed with a reader application), etc.

A computer program such as a web application, a mobile application, a software application and the like reside on the device ‘A’. Alternately, the computer program may be resident on the cloud and accessed by the device ‘A’ via a network. In such case, a plugin or software instructions may be required in the browser to access the computer program.

The one or more devices ‘A’ of the present invention are used for requesting and accessing article related information. The end user may request and access the article related information via the device ‘A’ by entering the PIR (or the identifiers) of the article.

The server 30 may be a remote server or a local server. The server 30 may be provided with a database 30a for storing useful information. The database 30a may store the article related information provided by the at least one electronic device ‘B’ in real-time. A server may have computer readable storage medium, for example, but not limited to, volatile memory, such as static random-access memory (SRAM)/dynamic random-access memory (DRAM), and/or a non-volatile memory, such as read-only memory (ROM), erasable programmable ROM, flash memories, hard disks, optical disks, or magnetic tapes. In an embodiment, the database 30a may store the names and contact details of the workers, company, the details relating to the article, etc.

The database 30a may include lookup tables for storing mappings between the at least one identifier used in the system and the article related information thereby storing the respective article related information corresponding each of the article separately. The identifiers may include, without limitation, PIR, name of the worker, the stage, location, completion percentage and other ancillary information. In an embodiment, the database 30a may include a look-up table having mappings of PIR, name of the worker, the stage, location, completion percentage and other ancillary information. Additionally/optionally, the look-up table may include reference id of the worker, PIRs of the worker, details of the products, etc. The data in the look-up table may be processed to predict the sales strategies/growth, customer satisfaction, marketing management strategies, etc. The identifiers may be stored on the server 30 and accessed from any geographical location.

The network 40 may be a global area network (GAN), such as the Internet, a wide area network (WAN), a local area network (LAN), or any other type of network or combination of networks. The network 40 may provide for wired, wireless, or a combination of wired and wireless communication between devices in the network. In some embodiments of the invention the network 40 described herein may be a cloud computing network.

Cloud networking, or cloud-based networking, gives users access to networking resources through a centralized third-party provider operating inter-connected servers.

The above system 100 may operate in a synchronized manner to allow data storage/upload and data transmission.

As an exemplary embodiment, say, the manufacturer wishes to know the status of the article in the manufacturing chain using the system 100. In such a case, the manufacturer via device ‘A’ may first make a request to the server 30 for procuring the status updates by providing the PIR of the said article as input. The device ‘A’ may be installed with an application for requesting and accessing the article related information.

The server 30 may then look up for the updates in relation to the article for which the PIR was provided using a processor. At this point, the processor would search for all the article related information saved in the database 30a by the one or more devices ‘B’. The server 30 then communicates with the device ‘A’ and the updates are displayed on the device ‘A’ for the end user's reference.

Alternately, if the end user is a consumer, the consumer may make a request to the server 30 in the same manner and retrieve article related information. In another embodiment, the finished article may be provided with the chip tag 20. The chip tag 20 may be disposed over a pre-defined surface of the finished article. The chip tag 20 may include all the article related information (or data).

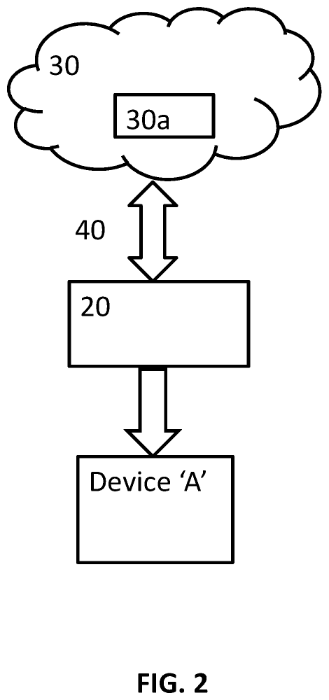

The chip tag 20 may include a tiny radio transponder, a radio receiver and transmitter. When triggered by an electromagnetic interrogation pulse from a nearby chip tag reader device, the chip tag 20 transmits digital data, usually an identifying inventory number, back to the reader. The data encoded in the chip tag 20 may be easily accessed by the user via the device A′ as shown in FIG. 2.

The device ‘A’ may include a reader for decoding and displaying the data encoded in the chip tag 20. The reader of the electronic device ‘A’ may be configured to scan the chip tag 20 and access the article related information at any given time during the manufacturing of the article and/or after the article has been manufactured.

The reader may be any conventional reader such as without limitation, a scanner, a reader, etc. The reader may collect the article related information by techniques. When triggered by an electromagnetic interrogation pulse from a nearby chip tag reader device, the chip tag 20 transmits digital data, usually an identifying inventory number, back to the reader. The reader may include a processor. Alternately, the processor may be an external processor.

Post scanning, the data stored in the chip tag 20 may be transmitted as analog signals which may then be decoded by the processor. The processor may be an integral component of the device A′. The data in the chip tags 20 may be transmitted through wireless communication. An air-interface protocol may be followed for standard passive HF (high frequency) and UHF (ultra-high frequency) tags.

Hence, as evident, the manufacturer or the user may be able to access the article related information encoded in the chip tag 20 relating to the article via the device ‘A’.

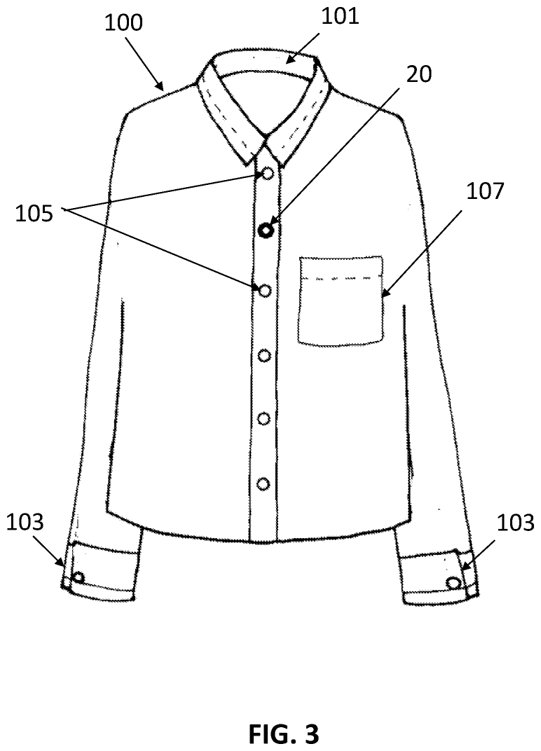

Referring to FIG. 3, an exemplary article 10 is disclosed. The article 10 in the present invention corresponds to a finished or unfinished piece of clothing, a piece of cloth/fabric or any fabric accessory. The article 10 may be any wearable or non-wearable article.

In an embodiment as shown in FIG. 3, the article 10 is a shirt. However, it should be noted that FIG. 3 is provided only for illustrative purposes and the scope of the invention also extends to other articles such as handkerchiefs, ties, shirts, t-shirts, pants, suits, jackets, jeans, tops, bedsheets, pillow covers, cushion covers, etc.

As shown in the exemplary embodiment depicted in FIG. 3, the article 10 includes a collar 101, a pair of cuffs 103, one or more closure means 105 and a pocket 107. The closure means 105 may be in the form of buttons, zip, knots, etc. In an embodiment as depicted in FIG. 3, the closure means 105 include a plurality of buttons.

The article 10 may be provided with at least one chip tag 20. The chip tag 20 may be provided on any pre-defined surface of the article 10. The pre-defined surface may be a concealed surface or a visible surface. It should be noted that the chip tag 20 is provided at a location that does not interfere with the comfort of the consumer.

The chip tag 20 may be provided separately or may be attached over the pre-defined surface of the article 10. The chip tag 20 may be temporarily or permanently attached to the article 10. Alternately, the chip tag 20 may be operatively coupled to the article 10 without any contact.

In an exemplary embodiment, when considering the article 10 to be a shirt, the chip tag 20 may be provided over one or more of the collar 101, the cuffs 103, the closure means 105 and/or a pocket 107. In an embodiment as shown in FIG. 3, the chip tag 20 is provided on the closure means 105.

Hence, the consumer via the device ‘A’ may access the article related information using the chip tag 20 provided on the closure means 105.

The foregoing description of preferred embodiments of the present disclosure provides illustration and description but is not intended to be exhaustive or to limit the disclosure to the precise form disclosed. Modifications and variations are possible in light of the above teachings or may be acquired from practice of the disclosure.

The scope of the invention is only limited by the appended patent claims. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

We claim:

1. An information processing system (100) comprising:
at least one electronic device ‘B’ for providing article related information relating to a corresponding article in real-time, wherein each article is associated with at least one identifier;
a server (30) configured to store the article related information provided by the at least one electronic device ‘B’ in real-time, wherein the server (30) including a database (30a) having at least one look-up table to store mappings between the at least one identifier and the article related information thereby storing the respective article related information corresponding each of the article separately;
at least one chip tag (20) in communication with the at least one electronic device ‘B’ and the server (30), the at least one chip tag (20) being encoded with the article related information received from the at least one electronic device ‘B’ in real-time;
at least one electronic device ‘A’ having a reader configured to decode the article related information; and
at least one communication channel (40) between the server (30) and the electronic device ‘A’ and ‘B’,
wherein the at least one chip tag (20) is operatively coupled to the article,
wherein each of the electronic devices ‘B’ is configured to upload the article related information in real-time at each manufacturing step during manufacturing of the article;
wherein the reader of the electronic device ‘A’ is configured to scan the chip tag (20) and access the article related information at any given time during the manufacturing of the article and/or after the article has been manufactured.

2. The information processing system (100) as claimed in claim 1, wherein the chip tag (20) includes a memory for storing the article related information regarding cloth and manufacturer.

3. The information processing system (100) as claimed in claim 1, wherein the chip tag (20) has multiple modes of communication with a database of the electronic device ‘B’ for storing the article related information.

4. The information processing system (100) as claimed in claim 1, wherein the identifiers include PIR, name of the worker, the stage, location, completion percentage and other ancillary information.
